(19) United States
(12) Patent Application Publication
(10) Pub. No.: US 2010/0125533 A1
(43) Pub. Date: May 20, 2010

(54) LIQUIDITY MANAGEMENT METHOD AND APPARATUS

(76) Inventors: Michael James Hoffmann, Belvedere, CA (US); Craig Adam Marmer, San Francisco, CA (US)

Correspondence Address: GLENN PATENT GROUP, 3475 EDISON WAY, SUITE L, MENLO PARK, CA, 94025, US

(21) Appl. No.: 12/560,329

(22) Filed: Sep. 15, 2009

Related U.S. Application Data
(60) Provisional application No. 61/115,839, filed on Nov. 18, 2008.

(51) Int. Cl. G06Q 40/00; G06F 17/30

(52) U.S. Cl. 705/36 R; 705/37; 707/E17.044

(57) ABSTRACT

A computer system is operated to allow an existing investor to keep an investment in an alternative investment fund, even though the existing investor lacks the funds to pay for the unfunded capital commitments by transferring a percentage of the obligation to fund future commitment to a prospective investor. An agreement maintains privity of contract between the existing investor and the investment vehicle (a Separate Account) comprised of a fund investment manager and an investor and is managed by a fund manager for the prospective investor. The computer system operates to execute the terms of the contract such that the existing investor receives distributions from investments in the underlying alternative investment fund after payment of amounts due to the Separate Account in preference to the existing investor.

### CROSS REFERENCE TO RELATED APPLICATIONS

This patent application claims the benefit of U.S. provisional patent application Ser. No. 61/115,839, Liquid Management Method and Apparatus, filed Nov. 18, 2008, the entirety of which is incorporated herein by this reference thereto.

### BACKGROUND OF THE INVENTION

1. Technical Field

This invention relates generally to the field of alternative investment funds. More specifically, this invention relates to systems and methods for pricing unfunded commitments and resulting distributions of investments in alternative investment funds.

2. Description of the Related Art

Alternative investments are any type of investment product that is not a publicly traded stock, bond, or cash. One type of alternative investment is private equity, which is an asset class consisting of equity, debt, or mixed securities in operating companies or assets that are not typically publicly traded on a stock exchange at the time of investment. Most often, they are held in the form of limited partnership interests in a limited partnership vehicle. An investor can buy or sell an existing position in such a fund in an existing private equity secondary market.

FIG. 1 is a prior art example of the hierarchy established by the issuance of interests in a private equity fund. The private equity fund 110 is created by a private equity firm, the fund sponsor, who functions as the general partner of the partnership vehicle. The fund manager 100 creates the private equity fund 110 to prospectively invest in a portfolio of investments 115N and manages the private equity fund 110 for investors. The investors 105 receive a limited partnership interest in the private equity fund 110 that represents their commitment to provide capital for the private equity fund 110 as and when it is called by the general partner for new investments, or additional investments in portfolio companies or assets, as well as to fund management fees and other expenses of the fund. The funding obligation for new investments may last from one to five years, depending on strategy and negotiations between the parties, and the overall life of the fund is typically ten years with some ability to extend the fund's life to accommodate a reasonable and prudent liquidation of the portfolio assets that cannot be sold during the initial term. The limited partners 105 in this model are typically large institutions, such as an insurance company, pension fund, foundation, endowment or sovereign wealth fund, etc.

Private equity funds 110 are funded with commitments from investors 105 to provide capital at the fund manager's 100 request, i.e., a capital call, or at predetermined dates for administrative charges to investors. For example, the investors 105 may have to pay a certain percentage of their commitment each quarter during the investment period for management fees owed to the general partner. A typical investment period may be three years and the life of the fund may be ten years.

The fund manager 100 receives a management fee for creating, managing, and administering the private equity fund 110. The management fee is typically an annual fee of 1-2% of the amount of the total capital committed to the private equity fund 110, and often the fee is reduced after the investment period has expired and is based on invested asset value as opposed to the limited partner's commitment amount.

Once the private equity fund 110 matures, the investors 105 receive one or more distribution(s), as the fund liquidates its investment positions. The distributions from the investments are divided into three stages: (1) the investor 105 receives a return of its invested capital; (2) the investor 105 receives a preferred annual return; and (3) the investor 105 and the fund manager 110 split any profits available after the return of investor capital and the payment of the preferred return to the investors. The additional profit split received by the fund manager in (3) is commonly referred to as carried interest and is typically between five and twenty percent of the profits. This is also referred to as a “catch up.” The order of distributions of monies from the fund is referred to in the industry as a “waterfall”.

For example, the investor 105 commits to provide $100 of capital and the partnership agreement sets the preferred return at eight percent. At the time of distribution, the investor 105 receives the $100 in capital and eight dollars for each year since the initial investment as the preferred return. Lastly, any remaining profits are split between the investor 105 and the fund manager 110 according to a predetermined rate, e.g. an 80/20 split in favor of the investor 105. In this model, if there are ten dollars of remaining profits, the investor 105 receives eight dollars and the fund manager 110 receives two dollars.

Currently, institutional portfolios that include private equity funds as a substantial portion of the portfolio are experiencing capital allocation problems. The allocation problem is most acute in pension funds and endowments that have allocated capital over the last 24-36 months. These institutions experienced significant declines in the value of their readily tradable assets, e.g. stocks and bonds, due to the recession and ongoing crisis in the capital markets.

The Fair Accounting Standards No. 157 (FAS 157), which became effective for entities with fiscal years beginning after Nov. 15, 2007, has caused assets on the alternative investment side to be reported as having decreased in value as well, by imposing a fair value requirement in reporting asset value. The problems caused by this accounting treatment are new and different than what has occurred historically. Prior to FAS 157, most general partners reported the value of fund positions at the lower of cost or market value, and were slow to report changes in value absent a compelling event, resulting in much less variability in value in alternative fund investments in an institutional portfolio. Because the values of the publicly traded portions of portfolios are instantly impacted by the change in capital markets and the changes in value of portfolio assets in alternative investment funds are reported quarterly in arrears, and now in consideration of the new reporting requirement under FAS 157, there is incongruity in the reported values resulting in alternative portfolios that appear to be over-allocated, based on the asset allocation models most of these institutions use to manage their investment portfolios. This condition is referred to as the Denominator Effect.

In addition to dealing with “over-allocation” to alternative portfolios resulting from the Denominator Effect, institutional investors with allocations to alternative investment funds are also facing a material decline in realizations from existing positions (as deal volume has nearly ceased in the face of poor company 15, performance and a lack of debt for new acquisitions in response to the wide-spread economic crisis). This exacerbates a liquidity crisis resulting from general partners calling for additional capital for management fees and new deals because realizations historically provided a material amount of the cash used to fund such capital calls in what had been a partially self-funding process.

For example, if an institutional portfolio comprised 40% public stocks and 10% private equity funds at the beginning of the recession, the public stocks could easily have fallen 50% by the beginning of 2009. As a result, the public stocks become closer to 25% of the allocation, but the private equity funds in ratio may now comprise (by value) 20% of the portfolio. Both of these levels are likely violations of the investment policy, asset allocation models, and investment guidelines established by these investors.

When an investment firm's portfolio violates these guidelines, the investor has several options. The investor can request permission from the applicable oversight entity or committee to be over-allocated. This is typically rejected because the portfolio is carefully designed to have a certain balance of asset allocation, risk management, and income allocation and creating an exception undercuts the purpose of having the allocation in the first place. Alternatively, the investor can reduce the over-allocated exposure by selling some or all of the investments or reducing the future funding commitments to the alternative investment vehicles.

As discussed briefly above, in addition to the allocation problem, the investors may also experience problems having adequate liquidity to fund their alternative asset capital calls. When a large percentage of an investor's investment portfolio is in alternative investment funds, the investor may not have enough cash to fund capital calls from the fund managers to satisfy these capital commitments. In this case, the investor can sell other assets in the portfolio, e.g. fixed income, public securities, etc. or the investor can sell down the existing alternative investments.

In the current market, a sale of any existing assets comes at the price of a material discount to their likely future value. If the investor elects to sell a portion of the alternative investment funds, the valuation of the position is complex for a number of reasons; the investment includes a funded portion and an unfunded portion, understanding the value of the underlying investments can be complex, the assets having limited liquidity, are largely without voting rights and are subject to the terms and conditions of the limited partnership agreements. While there is a growing market for secondary purchases of these positions, in periods of uncertainty, the buyer requires very large discounts, such as 50-70% of the existing investment's value, and can additionally take further discounts related to the unfunded positions if they are concerned about the quality of future investments that the manager may make. Particularly during a recession, when the values of assets in the secondary market are volatile, there can be a wide gap between what value the current investor reasonably attaches to the investment and what a buyer is willing to pay.

Furthermore, when investors sell interests in this type of investment, they nearly always have to sell the investments at a loss and potentially lose out on distributions that become increasingly profitable as the economy recovers. This is particularly true for alternative investments where there is typically a 3-7 year lag between when an investment is made and a realization of value occurs, whether as a result of value developed by the private equity fund manager or as a result of improving markets, or both.

The buying of existing alternative investment fund positions is particularly difficult for newer sovereign wealth fund managers. A sovereign wealth fund is typically a very large state-owned investment fund comprising financial assets and other financial instruments invested for the benefit of the state's citizenry. Sovereign wealth funds have increased in size and number since the turn of the century. Many of the sovereign wealth funds are new investors of private equity funds. As a result, they lack the experience and resources to accurately price the existing investments in alternative fund portfolios, and to evaluate the quality of managers in order to ascribe appropriate value to unfunded positions for those funds with which they are unfamiliar.

### SUMMARY OF THE INVENTION

An embodiment of the invention provides a system and method for obtaining increased liquidity from an alternative fund without the need to determine value for the existing investments in the fund. This is done by bifurcating the existing and the unfunded positions of an investment in an alternative investment fund, leaving the existing investments with the current investor and instead laying off exposure of a percentage of the committed but uninvested capital to a prospective investor.

In one embodiment, an existing investor, i.e. a current investor, agrees to have a portion of its unfunded commitments in the alternative investment fund be funded by a prospective investor. The prospective investor's investment account is organized as a Separate Account, which is customized to the needs of the particular investor. The agreement by which this is accomplished is called a Separate Account Agreement, and the Separate Account is managed by a Separate Account Manager (SAM). Both investors agree to indemnify the other in the event that the other investor defaults on the contribution of capital as and when called by the fund manager for new investments, management fees, etc.

In this embodiment, both the existing investor and the prospective investor, i.e. the new investor receive a portion of the return on the investment in a new waterfall that is distinct and independent from the waterfall in the underlying fund agreement. The ultimate structure of the new waterfall will differ in each instance, be subject to negotiation, and will reflect the extent and value of provided liquidity in the market as between the two parties. For example, as an inducement to the prospective investor to agree to fund future capital calls, the prospective investor may receive a new, first priority distribution and additional incentives, such as a commitment fee, payable by the seller in addition to the agreed split of profits from the new investments made commencing on the effective date of the agreement between the parties.

By contractually allowing a prospective investor to participate in the funding of future capital calls (and not selling or otherwise transferring that obligation), the existing investor retains the ownership of the alternative investment fund, the direct relationship with the general partner, and the economic benefits that flow from the portion of the commitments that the existing investor has made, and agrees to continue to fund. This obviates the need for prospective investors to grapple with valuation of the existing investments in anticipation of acquiring them, and it importantly relieves the existing investor from realizing a loss on this transaction that would have materially negative implications for the overall portfolio. The terms of the private contract between the existing and the prospective investor include a waterfall unique to this agreement—that is an agreement on how to deal with all capital flowing back from investments made pursuant to the agreement—both for legacy profits, i.e. profits resulting from investments paid for entirely by the existing investor, and profits resulting from new investments, paid for in whole or in part with the prospective investor's capital.

The SAM is compensated by a combination of management fees, a share of any up front fees, and incentive fees that generally are a split of the profits between the prospective investor and the SAM if the profits exceed the preferred return payable to the investor in the Separate Account.

In one embodiment, a computer program proposes prospective investors, determines terms of the contract, records all the transactions, and calculates the portions of the distribution transferred to the prospective investor, the SAM, and the existing investor. In another embodiment, the SAM specifies the terms of the contract and the computer program calculates the distribution based on the terms of the contract and the information relating to the capital commitment and distributions with unique assumptions to account for the lack of sufficient detail from the underlying general partners in connection with certain distributions from realized transactions.

### BRIEF DESCRIPTION OF THE DRAWINGS

FIG. 1 shows a prior art example of the hierarchy established by the sale of interests in the equity fund;

FIG. 2 shows a block diagram that illustrates an alternative investment fund and a method of apportioning future commitments according to one embodiment of the invention;

FIG. 3 shows a block diagram that illustrates an apparatus for apportioning future commitments according to one embodiment of the invention;

FIG. 4 shows a block diagram that illustrates the different parties involved in the method of apportioning future commitments according to one embodiment of the invention;

FIG. 5 shows a simplified block diagram of the flow of money between the investors and the Separate Account according to one embodiment of the invention;

FIG. 6 is a flow diagram that illustrates the steps for apportioning future commitments according to one embodiment of the invention;

FIG. 7 provides an example of the modeling of the terms of a contract between a general partner and the limited partners according to one embodiment of the invention, together with one embodiment of the modeling for a Separate Account taking on some of the future funding requirements of an existing investor;

FIG. 8 is a comparison between examples of a straight secondary sale of the investment and a fund that transfers part of the commitment to unfunded capital to a prospective investor according to one embodiment of the invention;

FIG. 9 shows a detailed example of the distributions according to one embodiment of the invention;

FIG. 10A is a more detailed example of a projected schedule of distributions according to one embodiment of the invention; and

FIG. 10B is a detailed example of waterfall tables according to one embodiment of the invention.

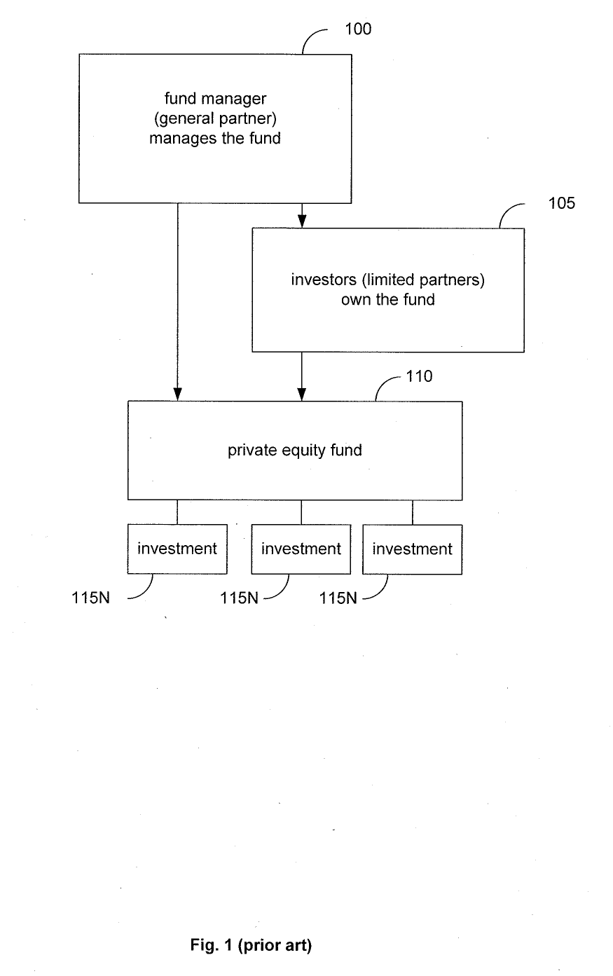

### DETAILED DESCRIPTION OF THE INVENTION

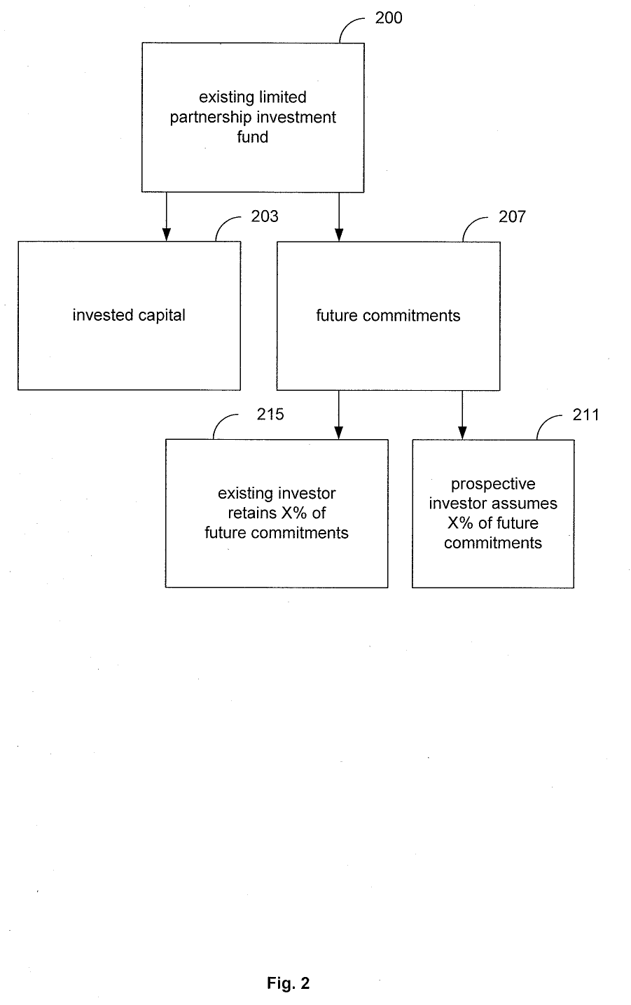

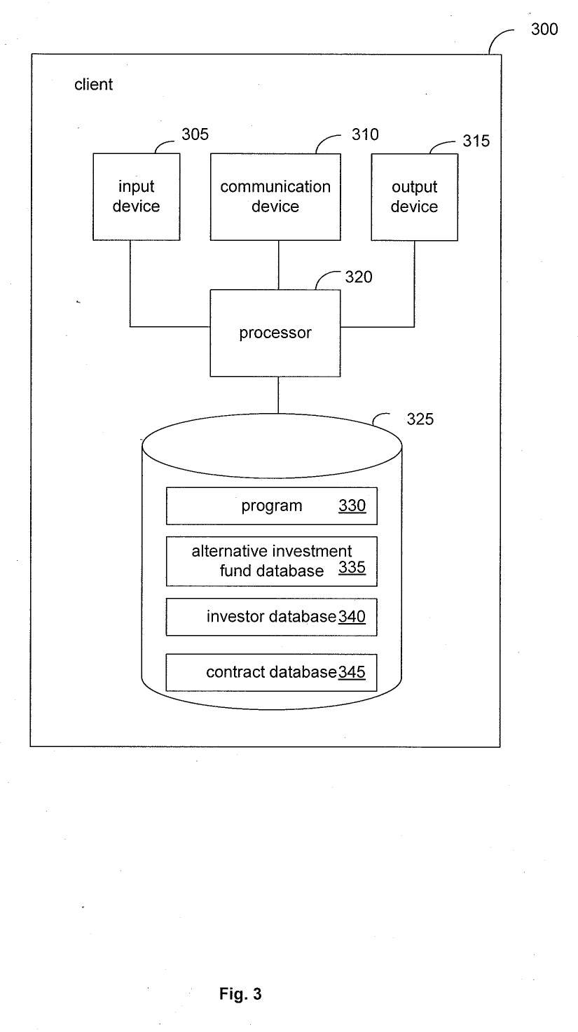

FIG. 2 is a block diagram that illustrates a private equity fund and a method of apportioning future commitments according to one embodiment of the invention. An existing limited partnership fund 200 is divided into invested capital 203 as of the date of a transaction involving the invention and future commitments 207, which is committed but uninvested capital, as of that same date. The existing investor retains all of the invested capital 203, and the rights to its return, subject to the waterfall between the Separate Account and the existing investor. In one embodiment, a general partner of the new investor, i.e. the Separate Account Manager (SAM) assumes with a prospective investor, a percentage of the existing investor's unfunded future commitments 211 to the existing limited partnership investment fund 200. The existing investor retains the remaining percentage of future commitments 215.

### Contractual Considerations

By sharing responsibility for capital contributions with a prospective investor, the existing investor receives the benefits of future distributions from both previously funded commitments and any retained unfunded future commitments, and relief from some of the obligation to contribute additional capital to the limited partnership fund. In one embodiment, the SAM assesses the creditworthiness of the existing investor before making an offer to the existing investor to commit to providing a share of the unfunded capital. If both the existing investor and the prospective investor are sovereign wealth funds (or equivalents) for example, the prospective investor's balance sheet and profile may be roughly similar to the existing investor and therefore an acceptable counter-party risk. If, on the other hand, the existing investor is experiencing significant decline in its overall asset value (or the continued flow of capital is impaired because of any number of different potential constraints on the source), the counter-party risk may be deemed to be too great to effectively back its obligations under the agreement (including the indemnity). In that instance, the counter-party would be rejected by the SAM.

Typically, the SAM will agree to a roster of acceptable alternative investment fund sponsors as part of the original Separate Account Agreement, and then both the SAM and the prospective investor must approve the inclusion of any new fund sponsors or the elimination of an originally approved fund sponsor.

Because this is a private contract between the parties creating a unique and proprietary private security, there is no transfer of interests, nor then is there an obligation to obtain approvals for transfers, which are typically required for a traditional secondary transaction. But this structure is flexible enough to allow parties to give the fund sponsors as much or as little transparency as they like in connection with the transaction. Most participants are likely to want to notify the existing investors of the transaction to enhance their relationships with the fund sponsors with whom, presumably, they will want to continue to do business.

The agreement between the existing investor and the prospective investor includes contractual privity so that the agreement to fund future commitments is enforceable against both the existing investor and the prospective investor. The contract includes provisions for dealing with defaults by either the existing investor or the new investor. For example, the non-defaulting party can sue the defaulting party to collect the unpaid sums, with interest and attorneys' fees in addition to having the right to fund the full capital call to protect the shared position in the fund. Other remedies will be negotiated on a case by case basis, but may include a reallocation of future cash flow and profits.

Other provisions may include the non-defaulting party's right to acquire the defaulting party's interest in the fund. Lastly, if there is dilution, or if there are other costs or risks incurred by the non-defaulting party under the terms of the underlying contract, the dilution and costs can be deducted from any distributions before the defaulting party receives its share of any future distributions.

In one embodiment, the prospective investor comprises multiple investors in an unfunded fund position provided that privity is maintained via the Separate Account Vehicle in each instance. Because the contract is between the existing investor and the prospective investor, the SAM need not disclose existence or terms of the agreement to the government or the general public under the Freedom of Information Act, although there may still be state-mandated disclosures for the parties' state or states of domicile or some public funds may determine that their policy requires some level of disclosure.

### Distributions

The terms of the contract stipulate potentially different percentages of the fund distributions for the prospective investor and the existing investor. The fund distribution is divided into distributions on investments funded entirely by the existing investor, i.e. legacy investments and investments funded in whole or in part by the prospective investor.

The contract also includes a commitment fee, which is a fee paid by the existing investor to the SAM and in one embodiment shared with the prospective investor for creating a stand-by facility that maintains sufficient liquidity to provide the funds necessary to meet capital calls at the time they are called. The commitment fee is a fixed percentage that is applied to the total stand-by facility and paid at the time of the facility creation, or it can be negotiated to be paid on a periodic basis. The receipt of a commitment fee compensates for an investor's willingness to encumber their balance sheet today and also offsets the management fee cost of the Separate Account Vehicle and finally mitigates further the J-curve associated with this investment.

In a typical waterfall involving the invention, any distribution is divided between the existing and prospective investors according to whether the distribution is a legacy distribution or whether the distribution was partially funded by the prospective investor. In one embodiment, the parties agree on how to divide a distribution that fails to provide sufficient information to determine whether it is a legacy distribution or the distribution was partially funded by the prospective investor. In this instance, the SAM calculates the results of the waterfall as between all parties based on the contract between the existing investor and the Separate Account, submits the analysis to an accounting firm (selected jointly by the existing investor and the new investor) for auditing, and then sends the analysis to the existing investor for final approval. Once the existing investor approves, or sufficient time has passed that it waives the right to object, the distribution is made to the parties. Any disagreement results in the amount at issue being placed in escrow and dealt with via an agreed expedited resolution process.

A distribution resulting from an arrangement involving the invention may be further divided to transfer a share of the profit to the SAM once the amount paid to the existing investor and/or the prospective investor exceeds the preferred return coming from legacy investments. In one embodiment, the profits (called carried interest), that exceed a preferred return is set at a fixed annual rate. In another embodiment, the carried interest is divided according to profits that exceed a multiple of the invested capital, e.g. 2.5 times, in which case, the invested capital may result in a higher percentage of profit for the SAM. Further details regarding the distribution are explained below using an example in conjunction with a computer program.

### System Hardware

In one embodiment, a client 300 comprises a computing platform configured to act as a client device, e.g. a computer, a digital media player, a personal digital assistant, etc. The client 300 comprises a processor 320 that is coupled to a number of external or internal inputting devices 305, e.g. a mouse, a keyboard, a display device, etc. The processor 320 is coupled to a communication device 310 that is configured to communicate via a communication network, i.e. the Internet. The processor 320 is also coupled to an output device 315, e.g. a computer monitor to display information.

The client 300 includes a computer-readable storage medium, i.e. memory 325. The processor 320 executes computer-executable program code stored in the memory 325. The client 300 includes a computer-readable storage medium, i.e. memory 325. The memory includes, but is not limited to, for example random access memory (RAM), an electronic, optical, magnetic, or other storage or transmission device capable of coupling to a processor, e.g. flash drive, compact disc-read only memory (CD-ROM), DVD, magnetic disk, memory chip, ROM, etc.

In one embodiment, the memory 325 stores a program 330 for controlling the processor 320. The processor 320 performs instructions of the program 330. The memory 325 also stores a private equity fund database 335, which contains the alternative investment fund's details (maturity data, investments, preferred returns, etc.), which is controlled by the SAM.

The investor database 340 contains a list of all the investors that have established accounts with the SAM, i.e. the limited partners and the financial data associated with their actual and prospective investments, e.g. amount of the investment, both committed and available, types of investments in which they are interested and in which they have positions, amount of uncommitted capital, distributions made, issue date of investment, next decision date, status, etc.

The contract database 345 stores the contracts between existing investors and prospective investors and includes the terms of each such agreement. Although the figure depicts three different databases for storing information, a person of ordinary skill in the art will recognize that the invention can be practiced using only one database, additional databases, or any combination thereof.

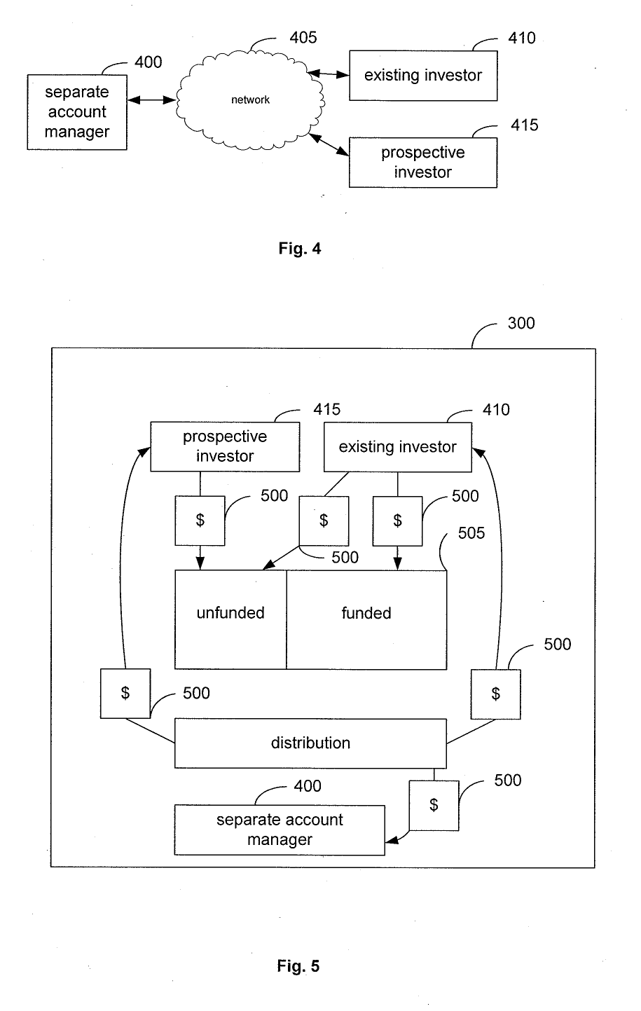

FIG. 4 illustrates one mode of communication between the SAM 400 and the investors according to one embodiment of the invention. A SAM 400 uses a client 100 to communicate via a network 405 with the existing investors 410 and prospective investors 415. The network can be a physical network such as a local area network (LAN), a wide area network (WAN), a home network, etc. or a wireless local area network (WLAN), e.g. Wifi, or wireless wide area network (WWAN), e.g. 2G, 3G, 4G.

In one embodiment, the SAM 400 uses the network 405 to communicate with the prospective investor 415 and the existing investor 410, for example, by suggest an arrangement between the prospective investor 415 and the existing investor 410. In another embodiment, the SAM 400 uses a client 100 to communicate via a network 405 to receive and process capital calls, execute and deliver transfer documents, and receive and process distributions.

FIG. 5 shows a simplified block diagram of the flow of money between investors and the SAM 400 according to one embodiment of the invention. The existing investor 410 contributed all the money 500 for the funded portion and part of the money 500 for the unfunded portion of the private equity fund 505. The private equity fund 505 generates distributions 510, which are paid to the prospective investor 415, the existing investor 410, and the SAM 400. All these transactions are monitored and recorded by the client 300, which determines the amount of money 500 to be distributed to each party to the arrangement.

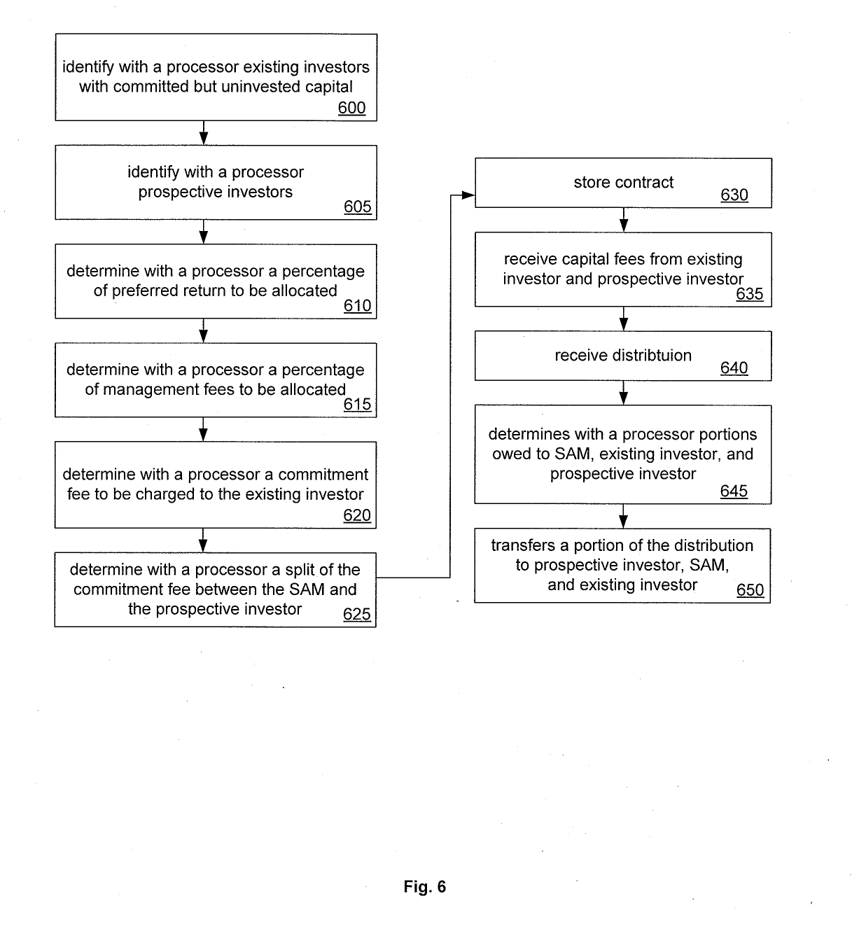

FIG. 6 illustrates a flow diagram for apportioning future commitments according to one embodiment of the invention. The client 300 identifies 600 with a processor 320 existing investors 410 with committed but uninvested capital from the investor database 340. In one embodiment, the SAM 400 narrows this group down further by identifying existing investors 410 that have less liquidity or are experiencing other factors contributing to a need for more immediate liquidity.

The client 300 identifies 605 with a processor 320 prospective investors 415 based on factors such as credit worthiness, liquidity, appetite for investment in alternative assets, and specific areas of interest within alternative assets. In one embodiment, the client 300 analyzes the investor database 340 for prospective investors 415. The prospective investor 415 may be identified based on its interest in assets of the type held by existing investor 410, its credit worthiness, its liquidity, etc. In another embodiment, the system includes a user interface for receiving at least one prospective investor 415 as input by a SAM 400.

Based on the amount of committed but uninvested capital for an existing investor 410, the client 300 determines 610 with a processor 320 a percentage of future commitment to be assumed by the prospective investor 415. This percentage includes not only how much the prospective investor 415 is contributing as capital, but also the duration and likely pacing of the funding of the commitment. The client 300 may use a default percentage or apply an algorithm that determines the percentage as a function of the existing investor's 410 and the prospective investor's 415 capacities to fund the commitment.

For example, if the existing investor 410 is so leveraged that it is on the verge of selling the investment, it may only be capable of paying 5% of all future commitments. Furthermore, if the prospective investor 415 is over-allocated to alternative investments, the need to reduce this over-allocation may require that the commitment be limited to 10% or less. In another embodiment, the client 300 includes a user interface for receiving input from a SAM 400 regarding the division of the investment and the associated economics (e.g., preferred returns, profit shares and costs) between the existing investor 410 and the prospective investor 415.

The client 300 determines 615 with a processor a percentage of preferred return to be allocated to the Separate Account. This preferred return is compensation to the Separate Account payable because of its willingness to assume an obligation from which the existing investor might otherwise find extremely difficult to obtain relief.

The client 300 determines 620 with a processor the level of commitment fee to be charged to the existing investor 410. The client 300 determines 625 with a processor a split of the commitment fee between the SAM and the prospective investor 415 to be allocated to the Separate Account. The commitment fee is compensation to the Separate Account payable because of its willingness to assume an obligation from which the existing investor 410 might otherwise find extremely difficult to obtain relief.

In another embodiment, the management fees are specified by the SAM 400 and received by the client 300 through a user interface. Once the terms of the contract are complete, the client 300 stores 630 the contract in the contract database 345.

During a call for capital, the client 300 receives 635 capital from either the existing investor, or 410 the prospective investor 415, or both. In one embodiment, the client 300 has an agreement set up with the parties to automatically withdraw the funds from bank accounts. All the transaction details are stored in the alternative investment database 335.

During distribution, the client 300 receives 640 a distribution for the alternative investment fund. The client 300 determines 645 with a processor 320 the portions owed to the SAM 400, the existing investor 410, and the prospective investor 415. The distributions are a function of the managing fee, the commitment fee, the original investment capital, the preferred rate of return, the excess commitment fee split, the difference between legacy distributions and distributions funded in part by the prospective investor, etc.

In one embodiment, the client 300 transfers 650 a portion of the distribution to the prospective investor 415, the SAM 400, and the existing investor 410 as determined by the client 300. In another embodiment, the distribution is transferred to an escrow account, with distributions made from that account, once the conditions to those distributions have been satisfied.

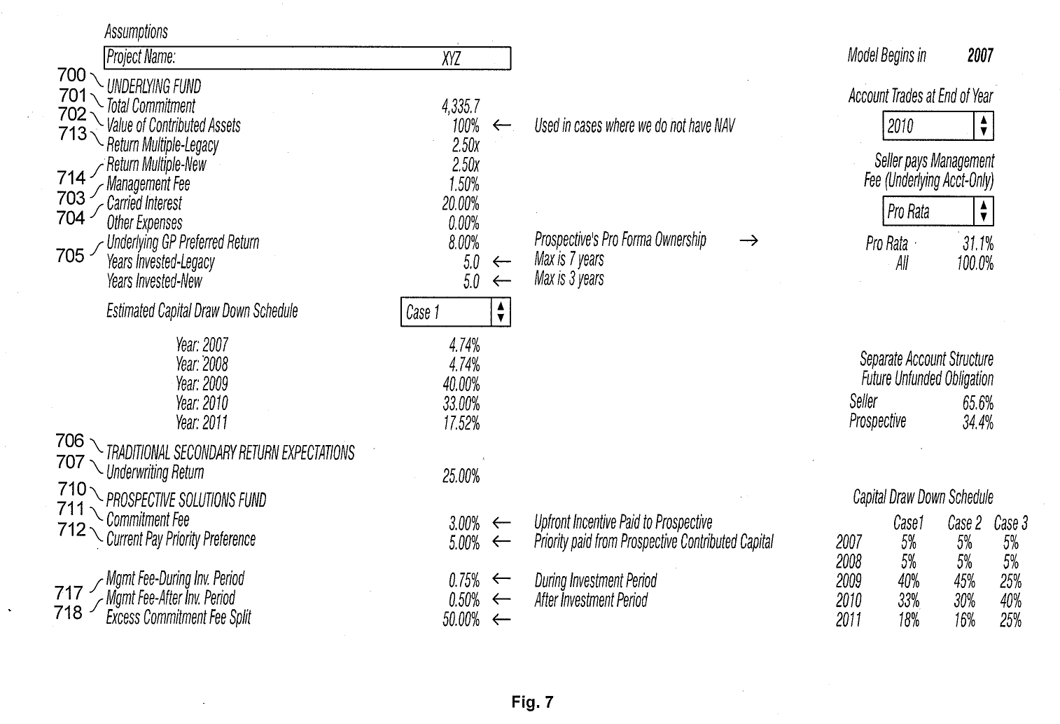

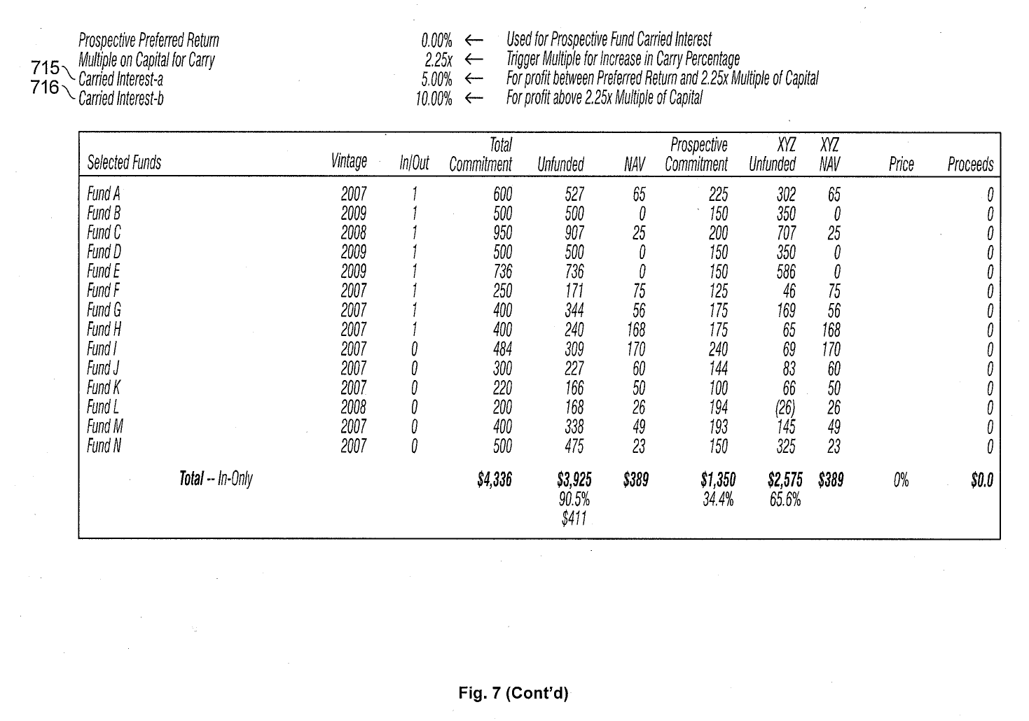

FIG. 7 provides an example of terms (assumptions) in a contract between a general partner and the limited partners according in an existing fund, along with an example of the assumptions for modeling one embodiment of the invention. FIG. 7 is divided into information about the underlying fund 700 through the underlying GP preferred return 705, and uses this information to compare what an existing investor might receive from a traditional secondary transaction 706, and the Separate Account 710 (called the Prospective Solutions Fund™) enabling the user of the invention to model and craft a solution specific to the existing investor's 410 and the prospective investor's 415 needs and interests.

The underlying fund 700 contains details about the alternative investment fund, including the existing investor's capital commitment 701, the existing investor's net asset value (“NAV”) is reflected as a percentage of the investor's capital account, the fund sponsor's management fees 703 expressed as a percentage of the existing investor's capital commitment (which is typically paid quarterly in advance), the sponsor's interest in the profits of the underlying fund 704, and the preferred return payable by the underlying fund payable prior to the funs sponsor being paid any profits 705, expressed as an annual percentage rate. When the NAV of the fund is unavailable, the value of the contributed assets 702 is set to 100%.

FIG. 7 also provides for a mechanism to model and compare how the use of the invention will compare with a traditional secondary transaction 706, based on a secondary buyer's return expectations 707, and through use of the invention. In this example, the traditional secondary return expectations 706 contain an underwriting return 707 of 25%. The specifics of the Separate Account and the contract between it and the existing investor 410 are modeled by reflecting the amount of the commitment fee 711 payable by the existing investor, any preferred return 712 payable to the Separate Account under the contract, which in this example is five percent per annum, the return expectations for money invested by the existing investor prior to the execution of the contract, the projected return to the existing investor under the contract, the SAM's carried interest 715 and 716 earned pursuant to its agreement with the new investor, the management fees payable during 717 and after 718 the investment period for the Separate Account, which are typically paid quarterly in advance.

The commitment fee 711 is a fee received by the prospective investor 415 for keeping sufficient liquidity available (whether through a line of credit or otherwise) to pay capital calls. Here, the commitment fee 711 of 3% is paid to the Separate Account at the execution of the contract between the Separate Account and the existing investor. While the management fees 717 and 718 are sufficient to cover the costs of managing the Separate Account, the carried interest 715 and 716 serves as an incentive for the SAM 400 to return a profit to the prospective investor 415. The prospective investor 415 receives a priority pay preference 712 of 5% from the contributed capital before the existing investor 410 receives a share of the invested capital. This is an additional incentive for the prospective investor 415 to contribute capital.

In this example, the SAM's carry has two tiers. The first tier (carried interest a 715) is payable after the new investor has received a return of its capital, plus the Priority Preference 712, is shown as 5% 715. The second tier (carried interest b 716) is payable once the new investor has received a 2.25 multiple of its invested capital 720.

During the investment period, the SAM 400 receives an annual management fee 717 of 0.75% for managing the Separate Account's investments, vetting new possible investments and its capital commitment. Once the investment period has ended, the SAM 400 receives an annual management fee 718 of 0.50% for managing and administering the distribution to the prospective investor 415.

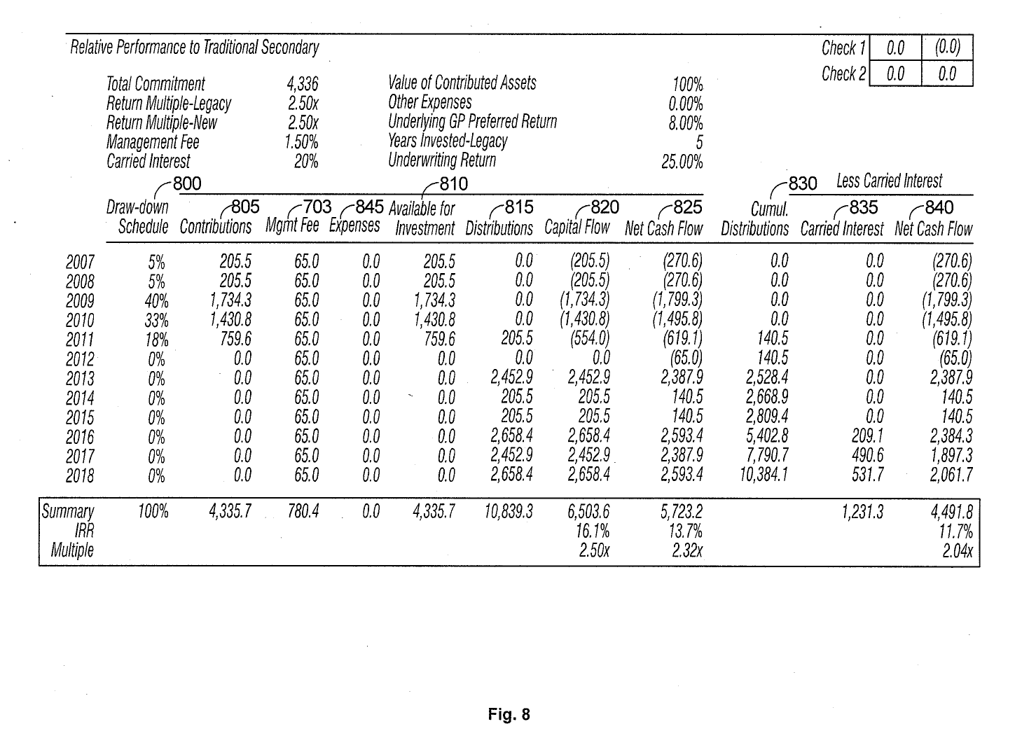

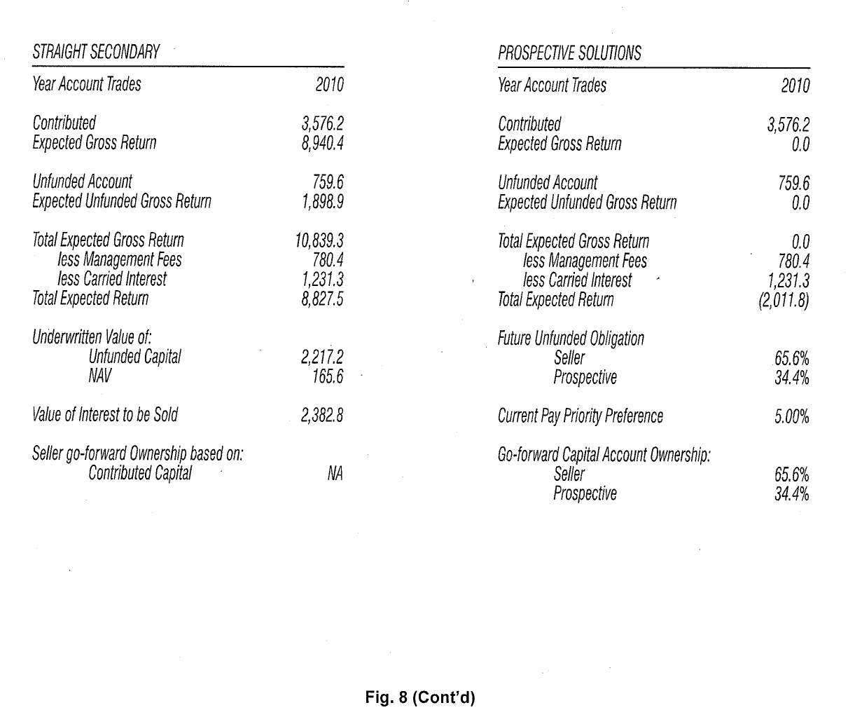

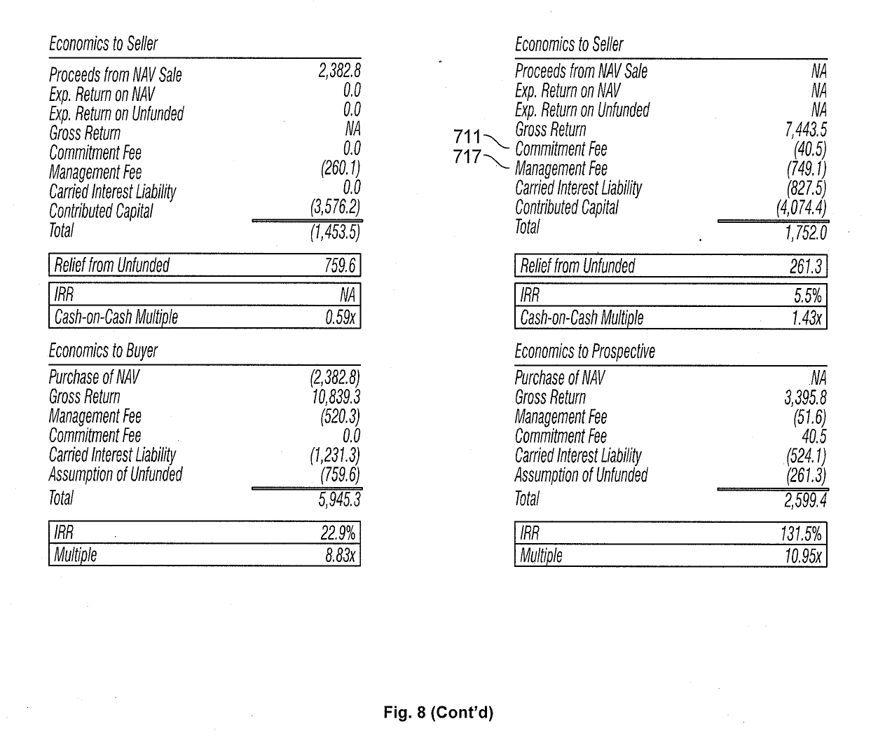

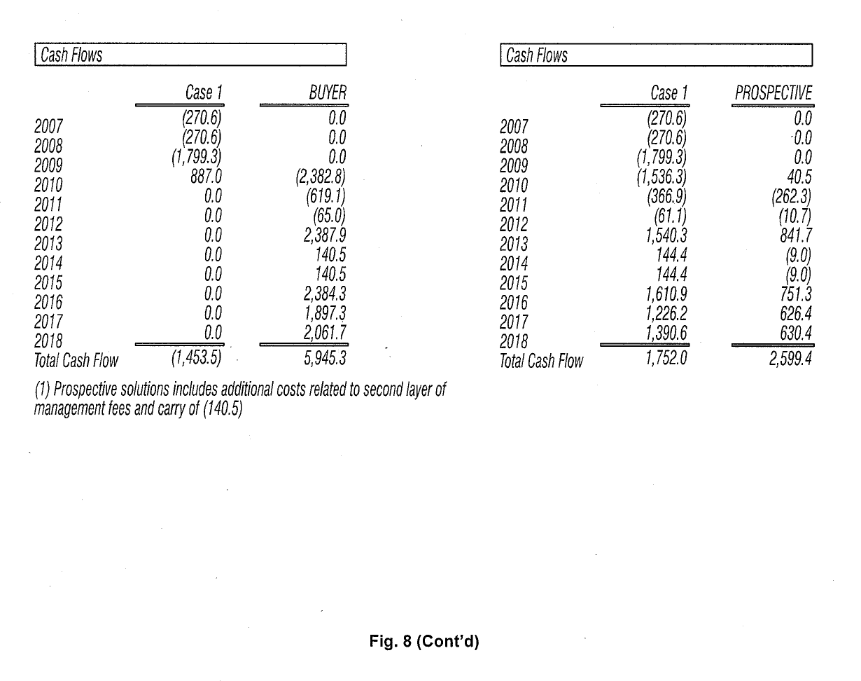

FIG. 8 is a comparison between examples of a straight secondary sale 850 of the existing investor's 410 investment and what might occur through use of the invention whereby a contract between the existing investor 410 and a Separate Account is created and the invention is put to use. In this example, the existing investor 410 transfers part of the commitment to fund capital commitments to the Separate Account (Prospective Solutions Fund™ 860) according to one embodiment of the invention. Under the straight secondary description, the existing investor's 410 entire interest in the alternative asset fund is 2,382.8, resulting in a loss of 1,453.5, and a 59% return of capital.

Using the Prospective Solutions Fund™ 860, on the other hand, a prospective investor 415 provides 34.4% of the unfunded capital. The gross return on the unfunded capital is 7,443.5. Once the commitment fee 711, the management fee 717, the carried interest payable to the SAM 835, and the contributed capital are subtracted from the gross return, the existing investor 410 makes a profit of 1,752.0. As a result, the existing investor 410 receives an internal rate of return (IRR) of 5.5% by using the Prospective Solutions Fund™ 860.

From the prospective investor's 415 perspective, committing to funding the existing investor's 410 unfunded capital commitment instead of purchasing the shares outright is also more lucrative. If the prospective investor 415 buys the existing investor's 410 interest in the alternative asset fund, the IRR is only 22.9%. Taking over the unfunded capital commitment, on the other hand, results in a 131.5% IRR. As a result, everyone benefits from Prospective Solutions Fund™ 860.

FIG. 8 also provides a yearly breakdown of the draw-down schedule 800 for the capital, the contributions 805 made to the fund, the management fee 717 payable to the SAM, the money available for investment 810, the distributions 815 payable to the Separate Account, the flow of capital out and into the Separate Account 820, the net cash flow 825 to the Separate Account, the cumulative distributions 830, the SAM's carried interest 835, and the net cash flow 840 to the prospective investor 415. The amount available for investment 810 is equal to the contributions 805 because in this example, there are no expenses 845. The yearly breakdown shows that the fund exceeds the 8% preferred return 705 after paying distributions for five years, at which point the SAM can start to earn money through its carried interest.

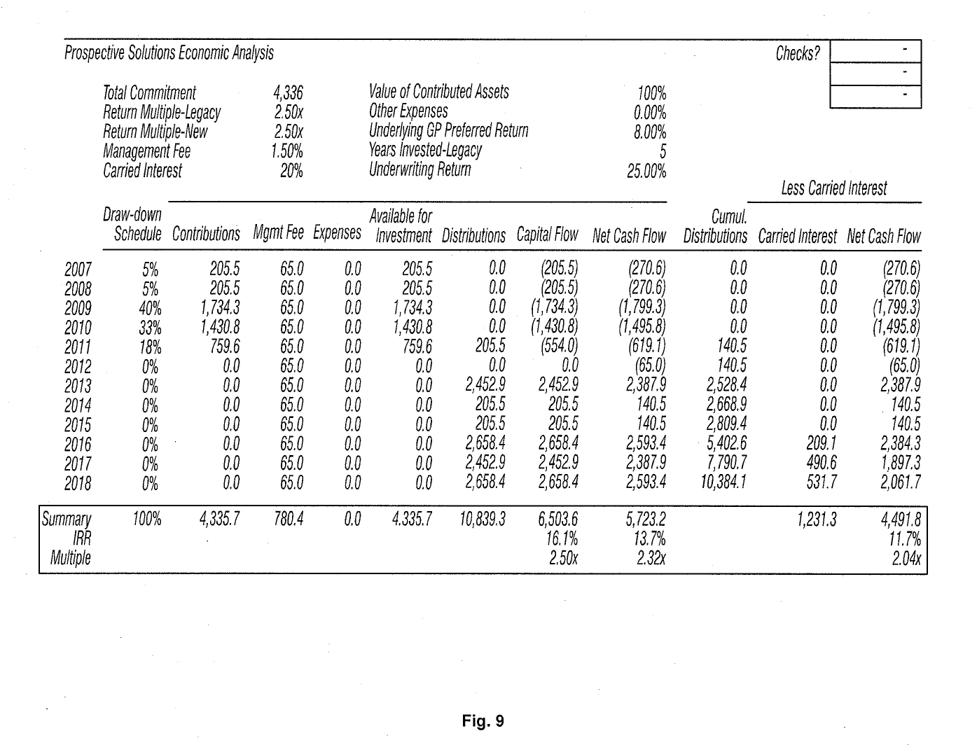

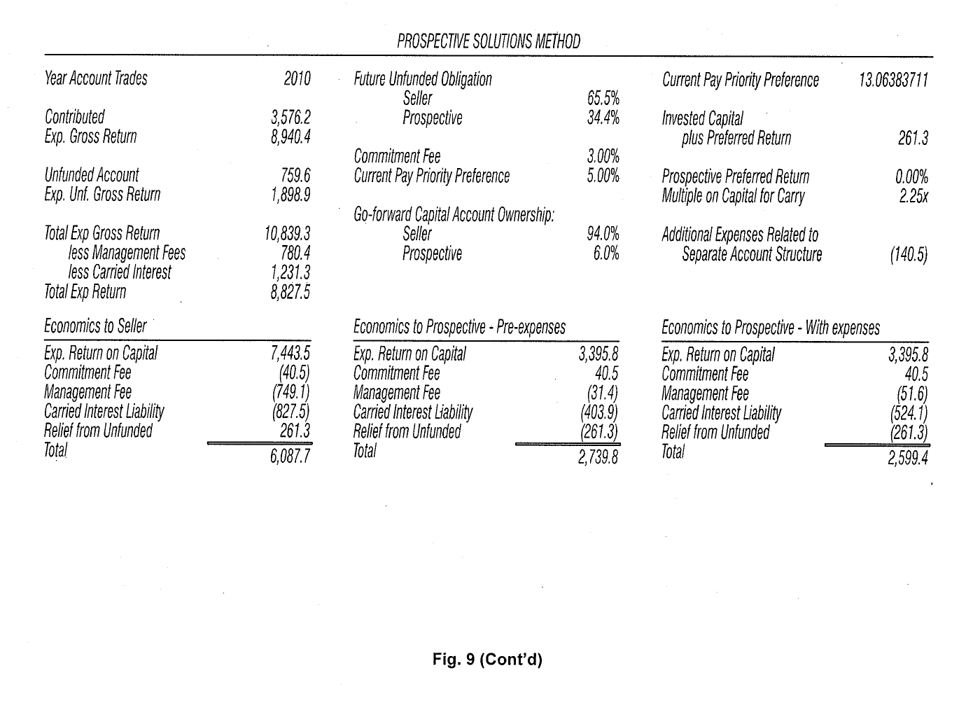

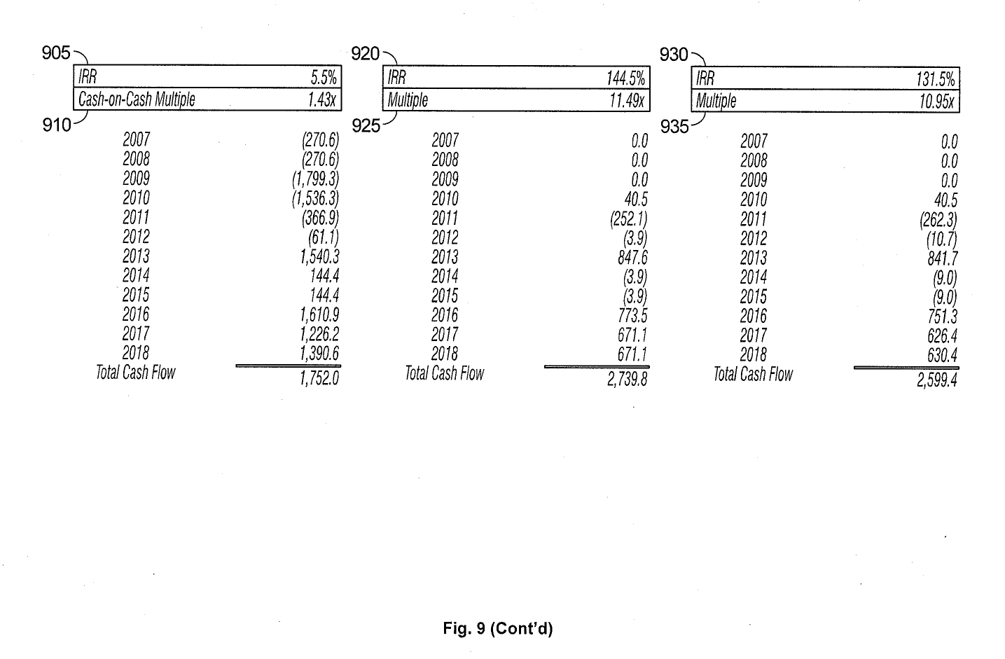

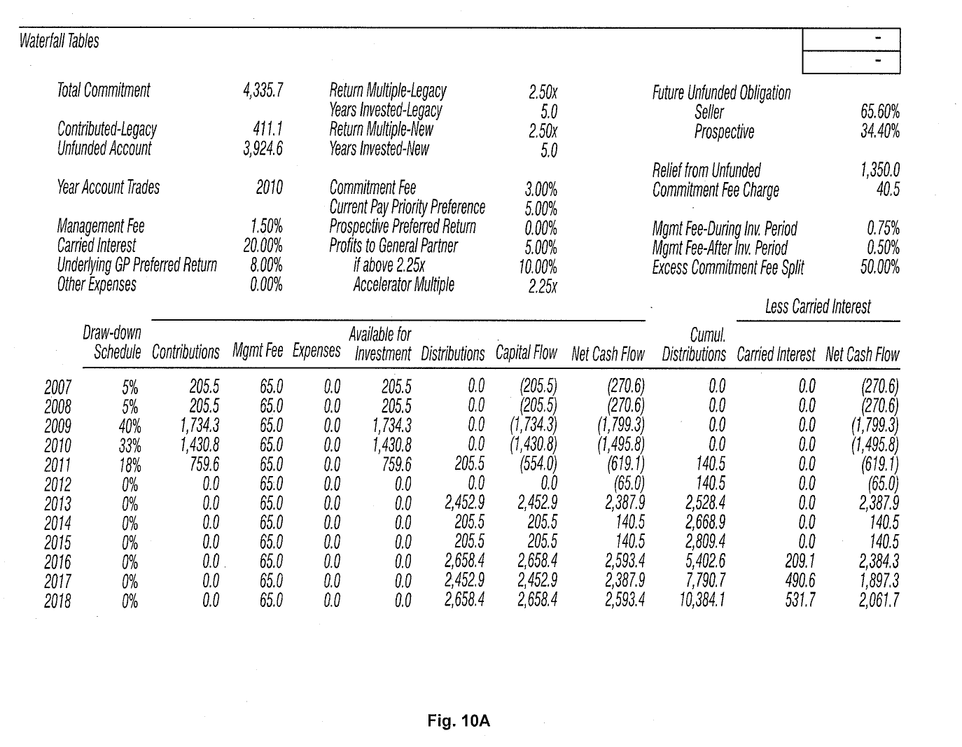

FIG. 9 shows a detailed example of the distributions according to one embodiment of the invention. The IRR for an existing investor 410 in an alternative asset fund that purchased a share is 5.5% 905, which is a cash-on-cash multiple of 1.43× 910. A prospective investor 415 receives a return before expenses of 144.5% 920, and after expenses of 131.5% 930. The multiples are 11.49× 925 and 10.95× 935, respectively. As a result, this example demonstrates how a prospective investor 415 can obtain a larger profit with less risk than a traditional secondary purchase.

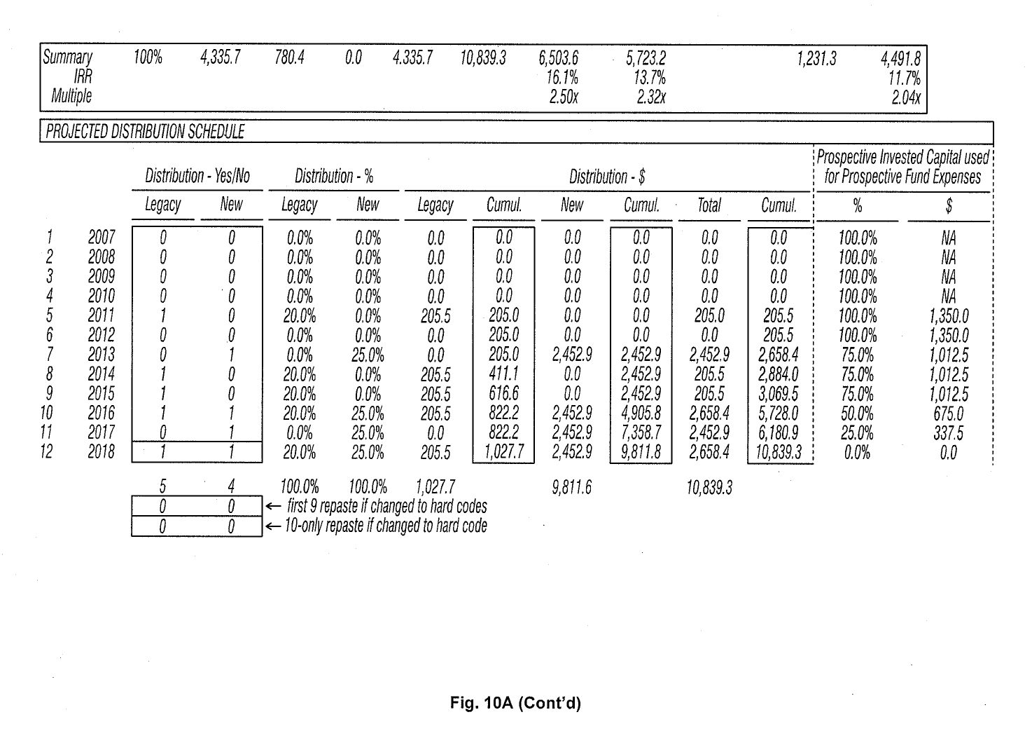

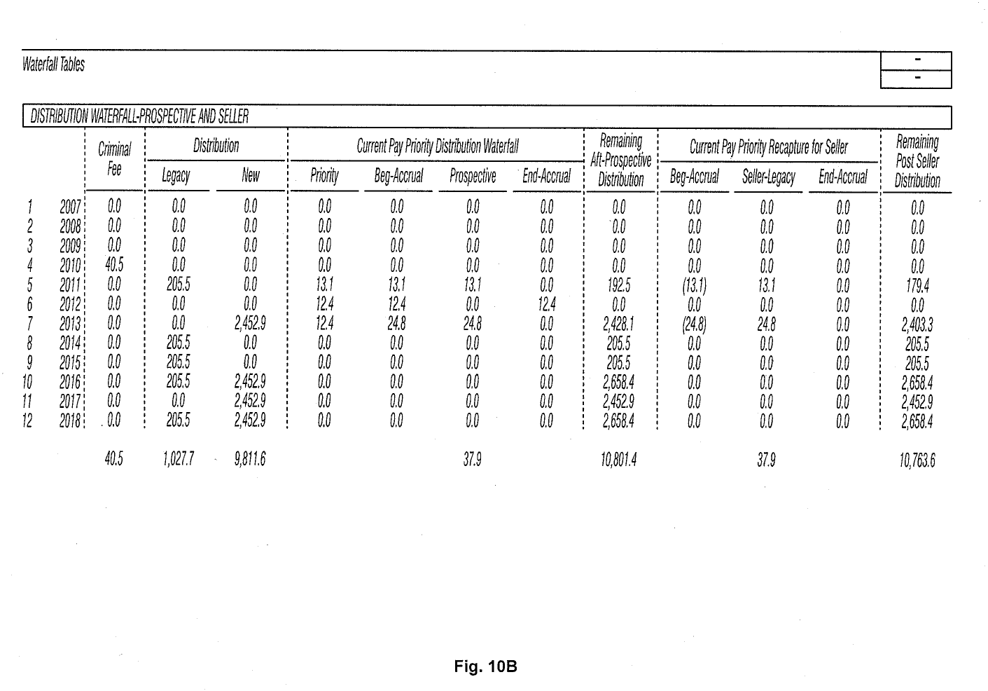

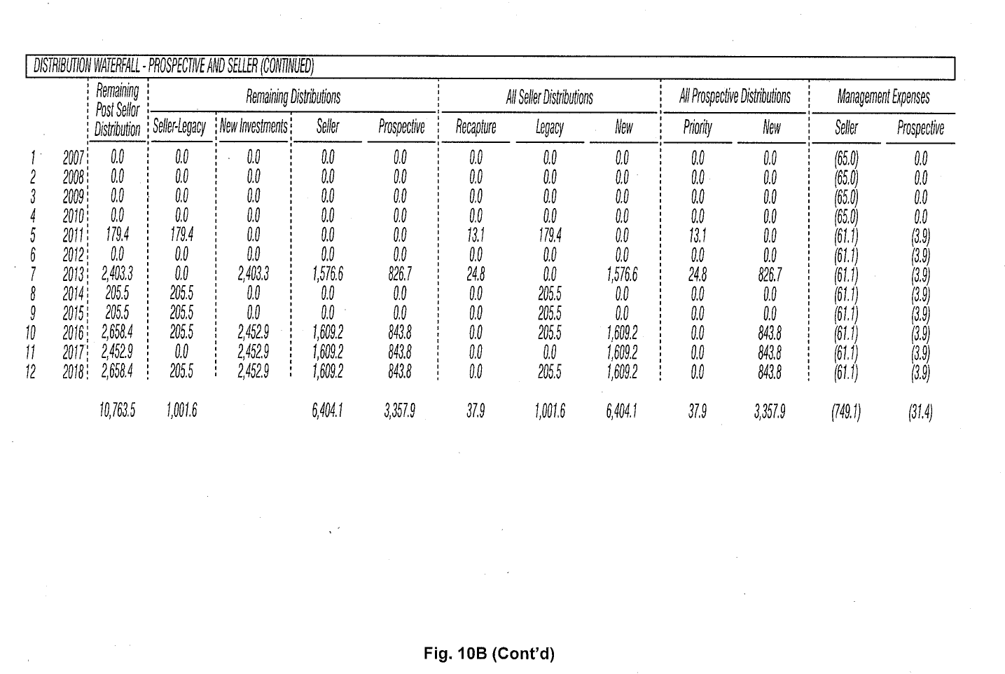

FIG. 10A is a more detailed example of a projected schedule of distributions, i.e. waterfall tables, that is divided according to whether the investment that resulted in the distribution was funded entirely by the existing investor 410, i.e. legacy investor, or whether the distribution was funded in part by the Separate Account investor 415, i.e. new investor, according to one embodiment of the invention. FIG. 10B is a detailed example of waterfall tables according to one embodiment of the invention.

As will be understood by those familiar with the art, the invention may be embodied in other specific forms without departing from the spirit or essential characteristics thereof. Likewise, the particular naming and division of the members, features, attributes, and other aspects are not mandatory or significant, and the mechanisms that implement the invention or its features may have different names, divisions and/or formats. Accordingly, the disclosure of the invention is intended to be illustrative, but not limiting, of the scope of the invention, which is set forth in the following Claims.

1. A computer-implemented method of funding commitments to provide capital to an alternative investment fund, the method comprising the steps of:
providing and propagating an investor database;
identifying with a processor an existing investor with committed but unfunded capital in the alternative investment fund from the investor database;
identifying with the processor a prospective investor from the investor database based on at least one of the prospective investor's creditworthiness, liquidity, appetite for investment in alternative assets, and interest in at least one type of interest held by the existing investor;
determining with the processor a percentage of the unfunded capital that the prospective investor will agree to fund as capital is called by the alternative investment fund;
determining with the processor a relative shares of all distributions to transfer to the prospective investor and the existing investor;
determining with the processor a percentage of management fees and carried interest for a separate account manager (SAM) for managing a Separate Account;
executing with the processor a plurality of terms of a contract among each of the existing investor, the SAM, and the prospective investor that details at least the percentage of unfunded capital to be paid by the prospective investor and the existing investor, the percentage of at least some distributions and any preferred returns by the alternative investment fund to transfer to the prospective investor and the existing investor, and the percentage of management fees and any carried interest to be transferred to the SAM;
accounting with the processor for capital contributed to the alternative investment funds by the existing investor and the prospective investor;
accounting with the processor for a plurality of distributions from the alternative investment fund; and
determining with the processor an amount of the distributions to transfer to the SAM, the prospective investor, and the existing investor based on the contract between the Separate Account and the existing investor, the source of capital, management fees, profits, losses, and carried interests, all in accordance with the terms of the contract.

2. The method of claim 1, further comprising the step of the processor executing the terms of the determined amount of the distribution to each of the SAM, the prospective investor, and the existing investor.

3. The method of claim 1, further comprising the steps of:
determining with the processor whether a distribution is a legacy distribution or whether the prospective investor contributed to the capital that funded the investment; and
subtracting with the processor amounts payable to the Separate Account as preferential amounts due under the contract between the existing investor and the Separate Account; and
transferring with the processor the rest of the legacy distribution to the existing investor.

4. The method of claim 1, wherein the management fee comprises a fee for establishing the private equity fund, a fee for managing capital calls, and a fee for managing distributions.

5. A system for funding an alternative investment fund, comprising:
a processor; and
a memory in communication with the processor and storing instructions adapted to be executed by the processor to:
identify with a processor an existing investor with committed but unfunded capital in the alternative investment fund from a database;
identify with the processor a prospective investor from the database based on at least one of the prospective investor's creditworthiness, liquidity, and interest in assets similar to those held by the existing investor;
execute with the processor a plurality of terms of a contract among each of the existing investor, the SAM, and the prospective investor that details at least the percentage of unfunded capital to be paid by the prospective investor and the existing investor, the percentage of at least some distributions by the alternative investment fund to transfer to the prospective investor and the existing investor, and the percentage of management fees and any carried interest to be transferred to the SAM;
store the terms of the contract in the database;
account for a plurality of data comprising capital provided by the existing investor, capital provided by the Separate Account, and the distributions;
store the plurality of data in the database; and
determine with the processor an amount of the distributions to transfer to the SAM, the prospective investor, and the existing investor based on at least the percentage of unfunded capital to be paid by the prospective investor and the existing investor, any preferred return payable to the Separate Account, and any carried interest payable to the SAM.

6. The system of claim 5, wherein the database stores at least one of a private equity fund database, an investor database, and a contract database.

7. The system of claim 5, wherein the system distinguishes between a legacy distribution, a distribution funded entirely by the Separate Account, and a distribution that is funded by both the Separate Account and the existing investor.

8. The system of claim 7, wherein the commitment fee is paid in advance, to assure the availability of capital to fund capital calls, regardless of whether it the capital is actually called or not.

9. The system of claim 5, wherein the prospective investor receives the amount of the distribution before the SAM and the existing investor.

10. The system of claim 5, wherein there is privity of contract between the existing investor and the Separate Account.

11. The system of claim 5, wherein there may be multiple Separate Accounts contracting with an existing investor, as long as each Separate Account maintains privity with the existing investor.

12. The system of claim 5, wherein the alternative investment fund is a private equity fund.

13. A method for managing an alternative investment fund that is funded by an existing investor and a Separate Account, the method comprising the steps of:
identifying with a processor the existing investor with committed but unfunded capital in the alternative investment fund from a database;
identifying with the processor the prospective investor from the database based on at least one of the prospective investor's creditworthiness, liquidity, and interest in assets of the kind held by the existing investor;
receiving a contract that establishes the percentage of unfunded capital to be paid by the Separate Account and the existing investor, a percentage of a plurality of distributions to transfer to the prospective investor the Separate Account Manager and the existing investor, and a percentage of all distributions to be transferred to the Separate Account Manager as carried interest upon receipt of each distribution;
stores the contract in the database;
receives a plurality of data comprising capital provided by the existing investor, capital provided by the prospective investor, and a distribution;
stores the plurality of data in the database; and
determines with the processor an amount of the distribution to transfer to the SAM, the prospective investor, and the existing investor based on at least the percentage of unfunded capital to be paid by the prospective investor and the existing investor any preferred return payable to the prospective investor, and the amount of any carried interest payable to the SAM as contained in the contract.

14. The method of claim 13, further comprising the step of receiving via a user input a commitment fee to pay to the prospective investor and the Separate Account Manager at the onset of the contract.

15. The method of claim 13, further comprising the step of receiving via a user input a preferred rate of return on the distributions and wherein the preferred rate of return is used to determine the amount of the distributions to transfer to the SAM, the prospective investor, and the existing investor.

16. The method of claim 15, further comprising the step of receiving via a user input a percentage of a commitment fee split and wherein the commitment fee split is used to determine the amount of capital required to be contributed by the SAM, and how much is to be paid to the prospective investor.

17. The method of claim 13, wherein the processor distinguishes between a legacy distribution, a distribution funded entirely by an existing investor and a distribution funded by both the prospective investor and the existing investor.

18. The method of claim 13, further comprising the step of transferring the distribution to the SAM, the prospective investor, and the existing investor.

19. The method of claim 13, further comprising the step of:
determining with a processor whether the distribution is funded by the prospective investor if that information is unavailable; and
if no agreement can be reached or mandated by the contract, transmitting the distribution to an escrow account.

20. The method of claim 13, wherein the processor transmits funds to the existing investor, the Separate Account Manager and the prospective investor over a network.
